(19) United States
(12) Patent Application Publication
(10) Pub. No.: US 2006/0108056 A1
(43) Pub. Date: May 25, 2006

(54) Method and apparatus for foreign object detection in a composite layer fabrication process

(75) Inventor: Dennis P. Sarr, Kent, WA (US)

Correspondence Address: FITCH EVEN TABIN AND FLANNERY, 120 SOUTH LA SALLE STREET, SUITE 1600, CHICAGO, IL, 60603-3406, US

(73) Assignee: The Boeing Company, Chicago, IL (US)

(21) Appl. No.: 10/997,171

(22) Filed: Nov. 24, 2004

(51) Int. Cl. B44C 1/17; B32B 37/00; B32B 38/04

(52) U.S. Cl. 156/234; 156/277; 156/384; 156/272.2

(57) ABSTRACT

A method and apparatus are disclosed for a remnant of backing paper in parts fabricated from a sheet material. The apparatus includes: a backing paper for laminating to a sheet material; and a pattern printed on the backing paper for radiating a detection signal from the pattern through the sheet material in response to receiving an activation signal.

### FIELD OF THE INVENTION

The present invention relates to the detection of foreign objects in structures fabricated from a sheet material that is generally supplied with a backing paper, such as carbon fiber composites. More specifically, the invention relates to a method and apparatus for detecting a remnant of backing paper in parts made from layers of a sheet material supplied with a backing paper.

### BACKGROUND OF THE INVENTION

Carbon fiber composite materials are typically packaged in sheets with a backing paper that is removed during the fabrication of parts that are made from of layers of the carbon fiber composite. A common problem encountered in the manufacture of parts made from carbon fiber composite materials is a failure to completely remove the backing paper. If the backing paper is not completely removed, then the resulting composite layup may not be structurally sound. However, remnants of backing paper that are embedded in a composite layup are typically difficult to detect. In a previous method used for detecting foreign objects in composite parts, ultrasonic non-destructive inspection is performed on each of the parts after performing an autoclave process step in which the layers of composite carbon fiber are bonded together under pressure. If foreign material is detected in the part, then the part is rejected or returned for rework.

### SUMMARY OF THE INVENTION

A method and apparatus are disclosed for detecting a remnant of backing paper in parts fabricated from materials supplied with backing paper.

In one embodiment, an apparatus includes:

a backing paper for laminating to a sheet material; and

a pattern printed on the backing paper for radiating a detection signal from the pattern through the sheet material in response to receiving an activation signal.

In another embodiment, a method includes steps of:

(a) providing a backing paper for laminating to a sheet material; and

(b) printing an electronically activated pattern on the backing paper for radiating a detection signal from the pattern through the sheet material in response to receiving an activation signal.

In a further embodiment, an apparatus includes:

first means for laminating to a sheet material; and

second means printed on the first means for radiating a detection signal from the second means through the sheet material in response to receiving an activation signal.

### DESCRIPTION OF THE SEVERAL VIEWS OF THE DRAWINGS

The embodiments described herein are illustrated by way of example and not limitation in the accompanying figures, in which like references indicate similar elements throughout the several views of the drawings, and in which:

FIG. 1 illustrates a sheet of carbon fiber fabric laminated with backing paper according to the prior art;

FIG. 2 illustrates a flow chart of a process for manufacturing a part from the carbon fiber fabric of FIG. 1;

FIG. 3 illustrates a remnant of backing paper embedded in a part during the fabrication process of FIG. 1;

FIG. 4 illustrates an autoclave process for bonding the layers of carbon fiber fabric together in the part of FIG. 3;

FIG. 5 illustrates a sheet backing system with an electronically activated pattern for detecting a remnant of backing paper having a minimum area;

FIG. 6 illustrates a backing paper imprinted with an electronically activated pattern for detecting a range of areas of a remnant of backing paper;

FIG. 7 illustrates a flow chart of a method of making the sheet backing system of FIGS. 5 and 6;

FIG. 8 illustrates a flow chart of a method of detecting a remnant of the imprinted backing paper of FIGS. 5 and 6;

FIG. 9 illustrates an apparatus for detecting a remnant of the imprinted backing paper of FIGS. 5 and 6; and

FIGS. 10A, 10B, 10C, 10D, 10E and 10F illustrate examples of various antenna patterns for RFID tags of the prior art that are suitable for printing on the backing paper of FIG. 5.

Elements in the figures are illustrated for simplicity and clarity and have not necessarily been drawn to scale. For example, the dimensions of some elements in the figures may be exaggerated relative to other elements to point out distinctive features in the illustrated embodiments.

### DESCRIPTION OF THE ILLUSTRATED EMBODIMENTS

A woven carbon fiber composite is typically used in the manufacture of parts that require high strength and light weight, for example, in aircraft. The carbon fiber fabric is generally supplied as a sheet laminated with a backing paper for shipping.

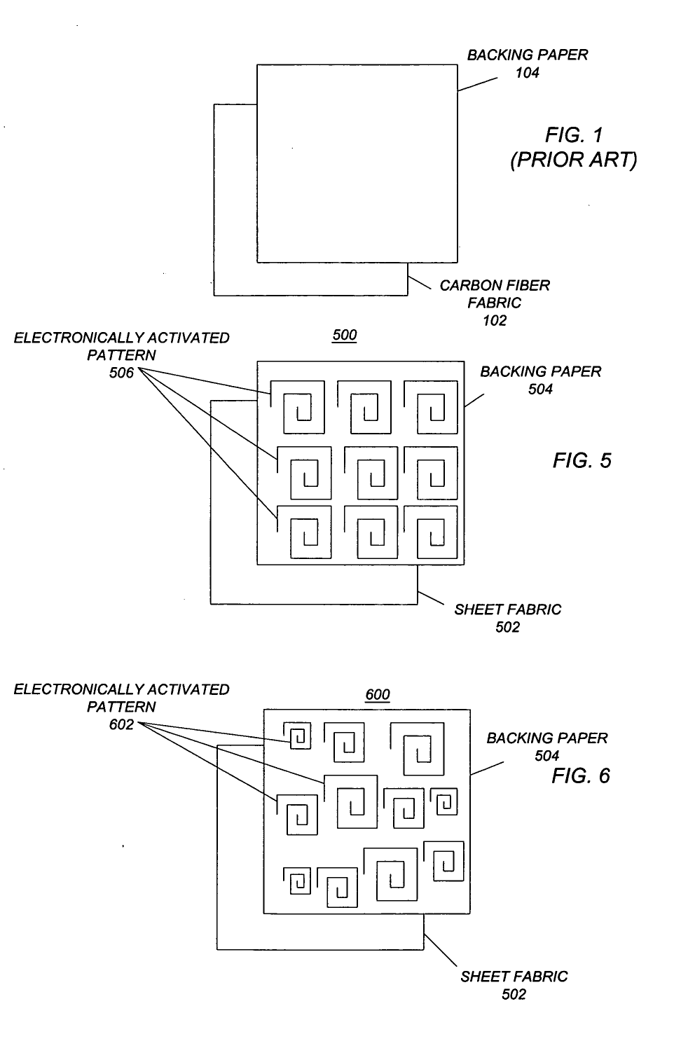

FIG. 1 illustrates a sheet of carbon fiber fabric 102 laminated with backing paper 104 according to the prior art. The backing paper 104 protects the sheet of carbon fiber fabric 102 from tears and contamination from foreign material during shipping. The sheet of carbon fiber fabric 102 is typically laminated with the backing paper 104 by an adhesive that allows the backing paper 104 to be stripped from the sheet of carbon fiber fabric 102 after shipping without damaging the sheet of carbon fiber fabric 102. The backing paper 104 may be made of, for example, paper or plastic.

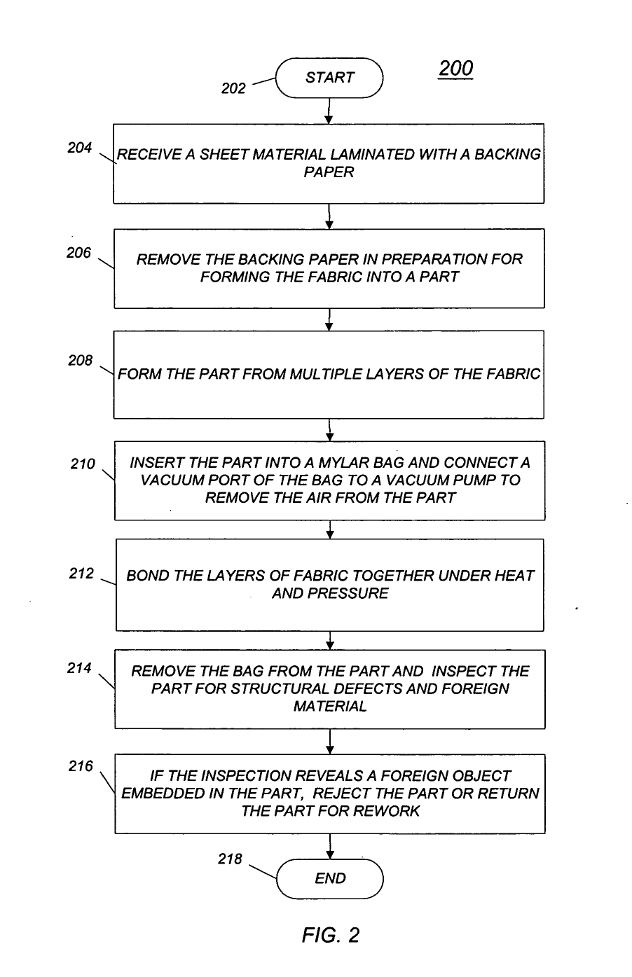

FIG. 2 illustrates a flow chart 200 of a process for manufacturing a part from the carbon fiber fabric of FIG. 1.

Step 202 is the entry point of the flow chart 200.

In step 204, a sheet of material laminated with a backing paper, for example, a carbon composite fabric, is received by a parts manufacturer.

In step 206, the backing paper is removed in preparation for forming the fabric into a part, for example, an aircraft wing.

In step 208, the part is formed from multiple layers of the fabric.

In step 210, the part is inserted into a mylar bag, and a vacuum port of the bag is connected to a vacuum pump to remove the air from the part.

In step 212, the bagged part is subjected to an autoclave process in which the layers of fabric are bonded together under heat and pressure.

In step 214, the bag is removed from the part, and the part is inspected for structural defects and specifically for the presence of foreign material such as a remnant of the backing paper that could reduce the strength of the part. The inspection is typically performed by analyzing the reflection of ultrasound from the part to find any remnants of backing paper that may be embedded in the part.

In step 216, if the inspection reveals a foreign object embedded in the part, the part is rejected or returned for rework.

Step 218 is the exit point of the flow chart 200.

A disadvantage of the method of FIG. 2 is that by the time the remnant of backing paper is discovered in the part, the remnant may not be removed without expensive rework, or worse, the part may have to be rejected, increasing the cost of production. A possible solution might be more careful monitoring of the process in which the backing paper is removed, however, this also adds significantly to the cost of production.

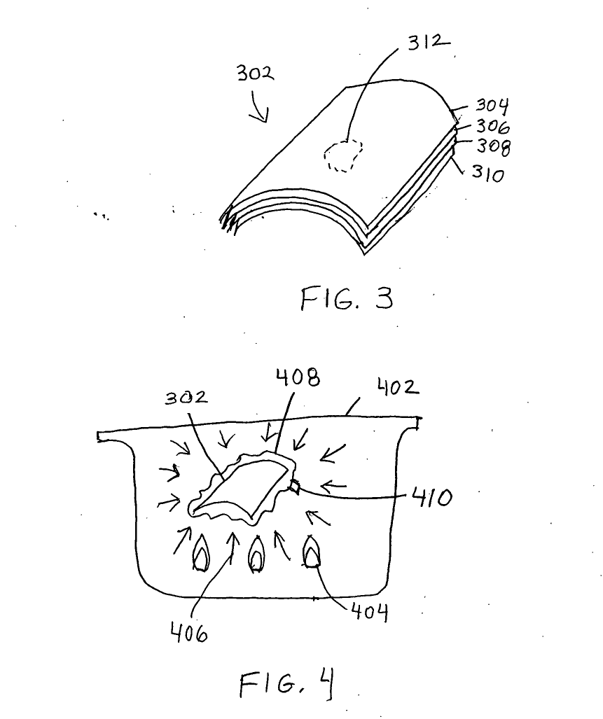

FIG. 3 illustrates a remnant of backing paper embedded in a part during the fabrication process of FIG. 1. Shown in FIG. 3 are a part 302, layers of carbon fiber fabric 304, 306, 308, and 310, and a remnant of backing paper 312.

In FIG. 3, the remnant of backing paper 312 was inadvertently left on the layer of carbon fiber fabric 308 when the backing paper was removed from the layer of carbon fiber fabric 308. After forming the layers of carbon fiber fabric 304, 306, 308, and 310 into the part 302, the remnant of backing paper 312 is embedded in the part 302.

FIG. 4 illustrates an autoclave process for bonding the layers of carbon fiber fabric together in the part of FIG. 3. Shown in FIG. 4 are a part 302, an autoclave 402, heat 404, pressure 406, a mylar bag 408, and a vacuum port 410.

In FIG. 4, the part 302 formed in FIG. 3 is inserted into the mylar bag 408. Any air trapped in the part 302 is removed by connecting the vacuum port 410 to a vacuum pump and evacuating the mylar bag 408 and the part 302. The autoclave 402 then applies heat 404 and pressure 406 to the part 302 inside the mylar bag 408 to bond the layers of carbon fiber fabric 304, 306, 308, and 310 together.

The ultrasonic methods used to detect remnants of backing paper left on the carbon fiber fabric are not always effective, especially for detecting remnants as small as, for example, a square centimeter. A preferable method of detection may be used to detect the smaller remnants before the autoclave process so that the remnants may be easily removed without expensive rework or loss of the part.

In one embodiment, an apparatus includes:

a backing paper for laminating to a sheet material; and

a pattern printed on the backing paper for radiating a detection signal from the pattern through the sheet material in response to receiving an activation signal.

FIG. 5 illustrates a sheet backing system 500 with an electronically activated pattern for detecting a remnant of backing paper having a minimum area. Shown in FIG. 5 are a sheet fabric 502, a backing paper 504, and an electronically activated pattern 506.

In FIG. 5, the sheet fabric 502 may be any material supplied as a sheet laminated to a backing paper that is removed when the material is used to manufacture a product. For example, the sheet fabric 502 may be a carbon fiber fabric. The backing paper 504 may be, for example, a sheet of paper having a size that may be conveniently accommodated by a printer, such as a printer used in conjunction with a computer. The paper or other material used for the backing paper 504 is preferably an electrical insulator. The electronically activated pattern 506 is printed with an electrically conductive material in the shape of an antenna or other suitable pattern that can radiate a signal in response to receiving an activating signal, such as a radio frequency signal. The size of the electronically activated pattern 506 may be selected to the resolution desired for a minimum remnant size, for example, one square centimeter. An electronically activated pattern in the context used herein is a pattern that is capable of receiving an electrical signal, for example, a radio frequency signal, and of generating an electrical signal in response to the received signal. The electrical signal generated by the pattern may be, for example, a radio frequency signal having a frequency that is of one of the frequencies in the activating signal, of a harmonic of a frequency in the activating signal, or the generated signal may have a frequency that is unrelated to the frequency of the activating signal.

The electrically conductive material used to print the electronically activated pattern 506 may be, for example, an electrically conductive ink contained in a printer cartridge for use with a printer in conjunction with a computer. Electrically conductive inks are commercially available, for example, from Precisia Co., and Dow Corning manufactures three types of electrically conductive inks: PI-1000 Solderable Polymer Thick Films, Thermoset Highly Conductive Silver Inks, and Thermoplastic Highly Conductive Silver Inks. The electronically activated pattern 506 may be designed, for example, with commercially available computer aided design (CAD) software and transmitted from the computer to the printer to print the electronically activated pattern 506 on the backing paper 504. The backing paper 504 imprinted with the electronically activated pattern 506 is laminated with the sheet fabric 502, for example, by an adhesive according to well known techniques as described with reference to FIG. 1. Processes for printing on inexpensive, noncoated packaging and Avery roll stock have been developed commercially by XINK, and Graphical Solutions International LLC has developed a process for depositing conductive ink in various resistance values that may be printed on a continuous roll.

FIG. 6 illustrates a sheet backing system 600 with an electronically activated pattern for detecting a range of areas of a remnant of backing paper. Shown in FIG. 6 are a sheet fabric 502, a backing paper 504, and an electronically activated pattern 602. The description of FIG. 6 is the same as that for FIG. 5, except that the electronically activated pattern 602 includes a plurality of sizes in which the shape of an antenna or other suitable pattern that can radiate a signal in response to receiving an activating signal is printed. The size of a remnant that includes one or more of the antenna sizes may be estimated by detecting which antenna sizes are included in the remnant. For example, if the detection signal radiated from the remnant has five frequencies, then the size of the remnant may be estimated as the sum of the areas of the five patterned antennas corresponding to the five frequencies. Also, an Israeli company, CrossID, has developed printable RFID tags using magnetic properties of specific chemicals. The particles of the chemicals resonate when subjected to electromagnetic waves. Each chemical emits its own distinct radio frequency that is sensed by a reader device, and the combination of all the frequencies sensed by the reader device is used to identify the tagged item. The National Institute of Advanced Industrial Science and Technology (AIST) of Japan is reported to have successfully developed the core technology for printing RFID chips. This technology, combined with other technologies such as printable antennas and printable batteries for RFID tags with active devices may be used to make a machine that can print these RFID tags. A variety of labels that may be printed on paper and synthetic materials, for example, for wristbands, are available as Zebra's Direct Thermal labels.

In another embodiment, a method includes steps of:

(a) providing a backing paper for laminating to a sheet material; and

(b) printing an electronically activated pattern on the backing paper for radiating a detection signal from the pattern through the sheet material in response to receiving an activation signal.

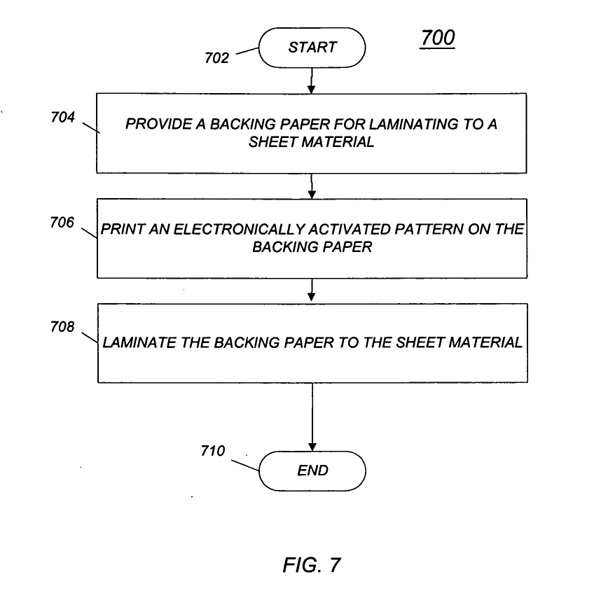

FIG. 7 illustrates a flow chart 700 of a method of making the sheet backing system of FIGS. 5 and 6.

Step 702 is the entry point of the flow chart 700.

In step 704, a backing paper is provided for laminating to a sheet material. The backing paper preferably has a high electrical resistance, and may be made of paper or another suitable material, such as plastic.

In step 706, an electronically activated pattern is printed on the backing paper for radiating a detection signal from the pattern through the sheet material in response to receiving an activation signal. The pattern may be, for example, a radio frequency antenna made of an electrically conductive material, for example, an electrically conductive ink.

In step 708, the backing paper is laminated to the sheet material according to well known techniques, for example, by an adhesive.

Step 710 is the exit point of the flow chart 700.

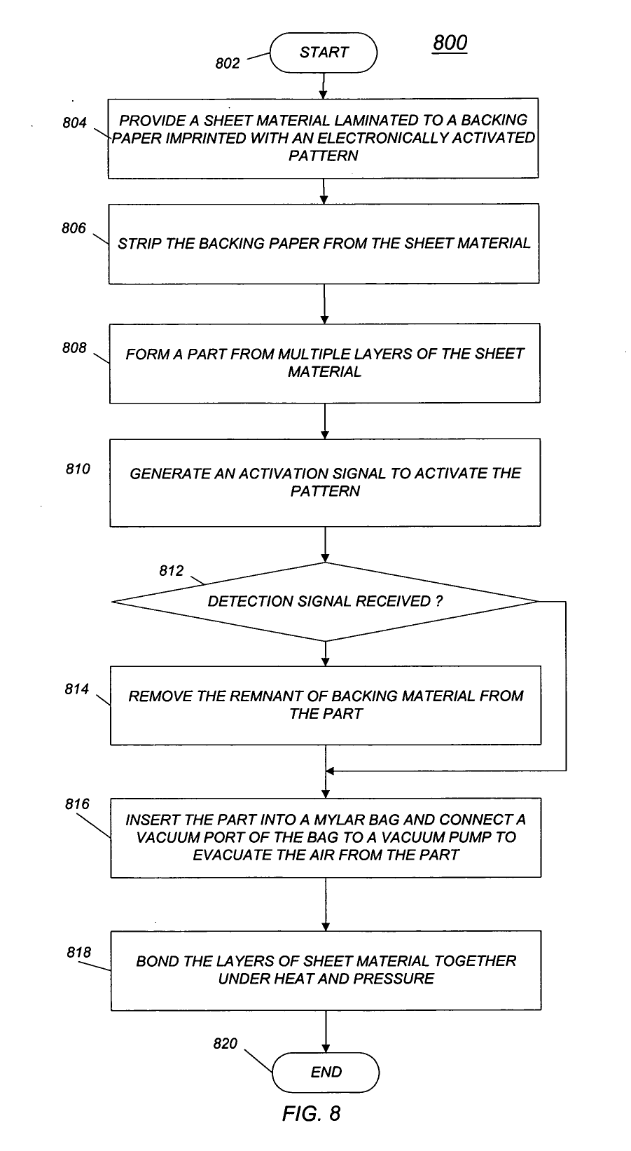

FIG. 8 illustrates a flow chart 800 of a method of detecting a remnant of the imprinted backing paper of FIGS. 5 and 6.

Step 802 is the entry point of the flow chart 800.

In step 804, a sheet material laminated with a backing paper imprinted with an electronically activated pattern as described with reference to FIGS. 5 and 6 is received by a parts manufacturer.

In step 806, the backing paper is stripped from the sheet material in preparation for forming the sheet material into a part, for example, an aircraft wing.

In step 808, the part is formed from multiple layers of the sheet material.

In step 810, the part is irradiated according to well known techniques by an activation signal, for example, a radio frequency signal. The source of the activation signal is preferably placed in close proximity to the part to ensure sufficient signal strength for penetrating layers of sheet material that may not be completely transparent to the electronic activation signal.

In step 812, if a detection signal radiated from the electronically activated pattern by a remnant of the backing paper that was not removed by stripping in step 806 is received by a detector, then the method continues from step 814. Otherwise, the method continues from step 816.

In step 814, the remnant of backing material is removed from the part.

In step 816, the part is inserted into a mylar bag, and a vacuum port of the bag is connected to a vacuum pump to evacuate the air from the part.

In step 818, the bagged part is subjected to an autoclave process in which the layers of the sheet material are bonded together under heat and pressure.

Step 820 is the exit point of the flow chart 800.

In the method of FIG. 8, the part is checked for remnants before the autoclave process, advantageously avoiding a possible loss of the part or a costly rework. Also, the electronically activated pattern provides a more robust detection signal than the ultrasound method of FIG. 1 for detecting remnants of backing paper. The ultrasound analysis may be used in addition to the electronic detection method of FIG. 8 if desired to detect the presence of other foreign material.

Although the flowchart descriptions above are described and shown with reference to specific steps performed in a specific order, these steps may be combined, sub-divided, or reordered without departing from the scope of the claims. Unless specifically indicated herein, the order and grouping of steps is not a limitation of other embodiments that may lie within the scope of the claims.

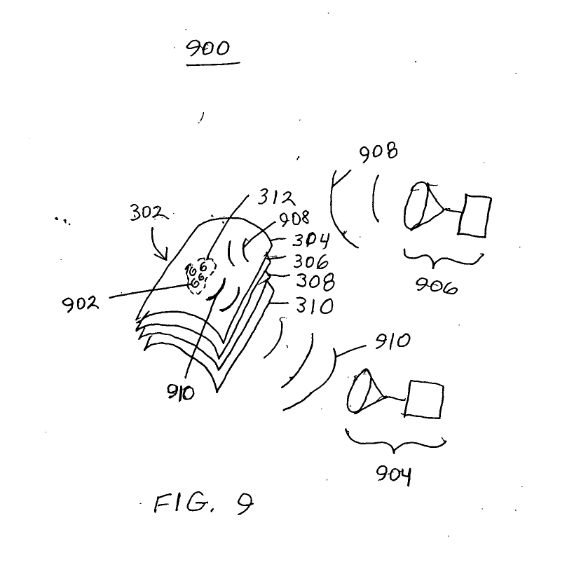

FIG. 9 illustrates an apparatus 900 for detecting a remnant of the imprinted backing paper of FIGS. 5 and 6. Shown in FIG. 9 are a part 302, layers of carbon fiber fabric 304, 306, 308, and 310, a remnant of backing paper 312, an electronically activated pattern 902, a detector 904, a activation signal generator 906, an activation signal 908, and a detection signal 910.

In FIG. 9, The part 302 is irradiated by the activation signal 908 from the activation signal generator 906. The activation signal 908 may be, for example, a radio frequency signal having only one frequency if the electronically activated pattern 902 has an antennas in only one size as in FIG. 5, or the activation signal 902 may be, for example, a radio frequency signal having multiple frequencies if the electronically activated pattern 902 has antennas in multiple sizes as in FIG. 6.

The detector 904 receives the detection signal 910 radiated from the electronically activated pattern 902 printed on the remnant of backing paper 312 in response to the activation signal 908. The size of the remnant may be estimated, for example, by the signal strength of the detection signal 910 if the electronically activated pattern 902 is that of FIG. 5, or by the range of frequencies in the detection signal 910 if the electronically activated pattern 902 is that of FIG. 6. A test part (not shown) having the same number of layers of the same sheet material without a remnant of backing paper may be used as a reference, if desired, to discriminate between the detection signal 910 and other background signal scattering.

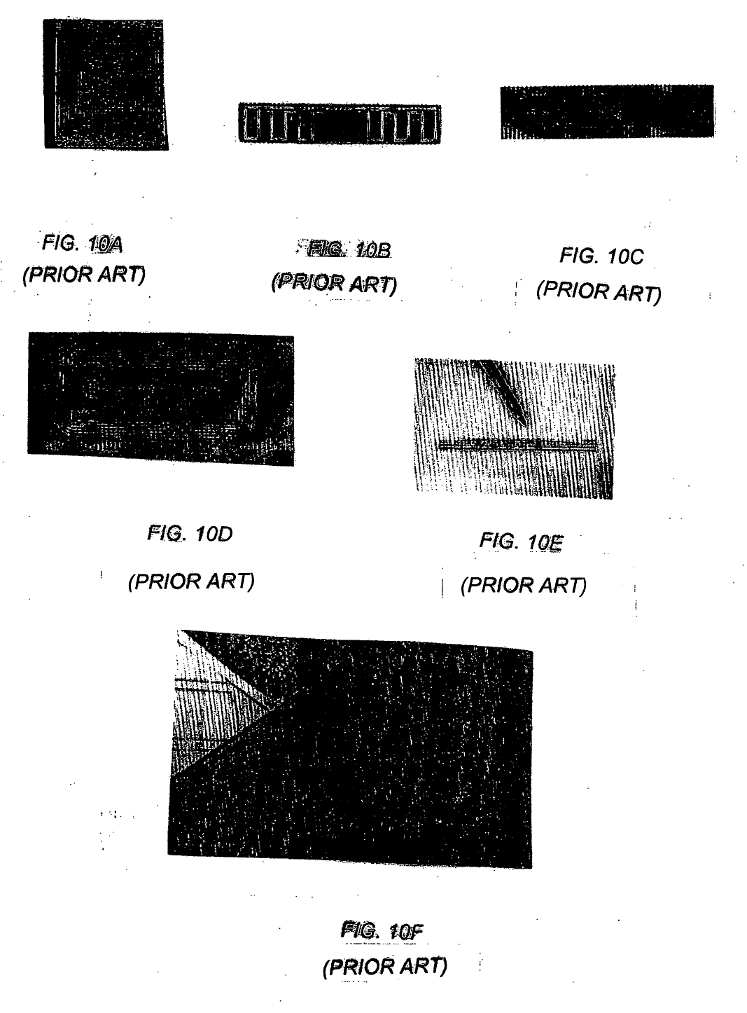

FIGS. 10A, 10B, 10C, 10D, 10E and 10F illustrate examples of various antenna patterns for RFID tags of the prior art that are suitable for printing on the backing paper of FIG. 5. For passive RFID tags, a loop antenna such as that illustrated in FIG. 10A may be used, for example, at an operating frequency of 13.56 MHZ. At this frequency, a few microhenries of inductance and a few hundred picofarads of capacitance are typically used. The transfer of signals between the detector and the loop antenna is accomplished by inductive coupling between the a loop antenna in the detector and the loop antenna of the RFID tag. The size of the example in FIG. 10A is about 5 cm by 5.5 cm at an operating frequency of 13.56 MHZ.

FIG. 10B illustrates the 2450 MHZ CIB Meander Free Space Insert.

FIG. 10C illustrates the Intellitag® tire RFID tag for operation at 869 MHZ and 915 MHZ. The Intellitag® insert may be used under an adhesive label or may be permanently mounted on a tire wall.

FIG. 10D illustrates a magnified image of an RFID tag used in Gillette Mach 3 razor blades.

FIG. 10E illustrates an RFID tag by SCS Corporation for operation at 915 MHZ compared in size to a pencil.

FIG. 10F illustrates a printed flexible antenna for wireless applications.

In addition to radio frequency antenna patterns, other electronically activated patterns may be printed in various sizes and arrangements to practice various embodiments of the sheet backing system described above within the scope of the appended claims.

The specific embodiments and applications thereof described above are for illustrative purposes only and do not preclude modifications and variations that may be made thereto by those skilled in the art within the scope of the following claims.

1. An apparatus comprising:
a backing paper for laminating to a sheet material; and
a pattern printed on the backing paper for radiating a detection signal from the pattern through the sheet material in response to receiving an activation signal.

2. The apparatus of claim 1 further comprising a detector for sensing the detection signal radiated from the pattern.

3. The apparatus of claim 1 wherein the pattern comprises electrically conductive ink.

4. The apparatus of claim 3 wherein the pattern is printed in a shape of at least one radio frequency antenna.

5. The apparatus of claim 4 further comprising an activation signal generator for generating the activation signal to activate the pattern over a distance separating the signal generator and a remnant of the backing paper left on the sheet material.

6. The apparatus of claim 5 wherein the radio frequency antenna has an area selected for estimating a minimum area of the remnant of the backing paper left on the sheet material.

7. The apparatus of claim 5 wherein the radio frequency antenna has an area selected from a plurality of areas for estimating a total area of the remnant of the backing paper left on the sheet material.

8. (canceled)

9. The apparatus of claim 1 wherein the backing paper comprises an adhesive for laminating the backing paper to the sheet material.

10. A method comprising steps of:
(a) providing a backing paper for laminating to a sheet material; and
(b) printing an electronically activated pattern on the backing paper for radiating a detection signal from the pattern through the sheet material in response to receiving an activation signal.

11. The method of claim 10 further comprising a step of sensing the detection signal radiated from the pattern.

12. The method of claim 10 wherein step (b) comprises printing the pattern with electrically conductive ink.

13. The method of claim 12 wherein step (b) comprises printing the pattern in a shape of at least one radio frequency antenna.

14. The method of claim 13 further comprising a step of generating the activation signal to activate the pattern over a distance separating the signal generator and a remnant of the backing paper left on the sheet material.

15. The method of claim 14 further comprising a step of selecting an area of the radio frequency antenna for estimating a minimum area of the remnant of the backing paper left on the sheet material.

16. The method of claim 14 further comprising a step of selecting an area of the radio frequency antenna from a plurality of areas for estimating a total area of the remnant of the backing paper left on the sheet material.

17. (canceled)

18. (canceled)

19. An apparatus comprising:
first means for laminating to a sheet material; and
second means printed on the first means for radiating a detection signal from the second means through the sheet material in response to receiving an activation signal.

20. The apparatus of claim 19 further comprising means for sensing the detection signal radiated from the second means.

21. The apparatus of claim 19 wherein the second means comprises electrically conductive ink.

22. The apparatus of claim 21 wherein the second means is printed in a shape of at least one radio frequency antenna.

23. The apparatus of claim 22 further comprising third means for generating the activation signal to activate the second means over a distance separating the third means and a remnant of the first means left on the sheet material.

24. The apparatus of claim 23 wherein the radio frequency antenna has an area selected for estimating a minimum area of the remnant of the first means left on the sheet material.

25. The apparatus of claim 23 wherein the radio frequency antenna has an area selected from a plurality of areas for estimating a total area of the remnant of the first means left on the sheet material.

26. (canceled)

27. (canceled)

28. The apparatus of claim 1 wherein the pattern comprises at least one radio frequency antenna having an operating frequency of about 13.56 MHZ and a size of about 5 cm by 5.5 cm.

29. A method for manufacturing a composite structure comprising steps of:
(a) providing a sheet material laminated with a backing paper imprinted with an electronically activated pattern;
(b) stripping the backing paper from the sheet material;
(c) forming the composite structure from multiple layers of the sheet material;
(d) irradiating the composite structure with an activation signal to detect a remnant of the backing paper in the composite structure identifiable from the electronically activated pattern;
(e) when a remnant is detected in step (d), then removing the remnant from the composite structure; and
(f) bonding the multiple layers of the sheet material together to complete the composite structure.

30. The method of claim 29 wherein the sheet material comprises carbon fiber.

31. The method of claim 29 wherein the electronically activated pattern is imprinted on the backing paper with an electrically conductive ink.

32. The method of claim 29 wherein the electronically activated pattern is printed in a shape of at least one radio frequency antenna.

33. The method of claim 29 wherein step (f) comprises heating the composite structure under pressure.
